(19) United States
(12) Patent Application Publication
(10) Pub. No.: US 2007/0029279 A1
(43) Pub. Date: Feb. 8, 2007

(54) Wood treating formulation

(75) Inventor: Marc H. Schneider, Fredericton (CA)

Correspondence Address: CHRISTIAN D. ABEL, ONSAGERS AS, POSTBOKS 6963 ST. OLAVS PLASS, NORWAY, N-0130, NO

(73) Assignee: WOOD POLYMER TECHNOLOGIES ASA, Oslo (NO)

(21) Appl. No.: 10/568,143

(22) PCT Filed: Aug. 13, 2004
(86) PCT No.: PCT/NO04/00247

§ 371 Date: Mar. 27, 2006

(30) Foreign Application Priority Data
Aug. 15, 2003 (NO) 20033639

(51) Int. Cl. B05D 1/18; B05D 3/00; B44C 1/22; C09K 13/00

(52) U.S. Cl. 216/29; 427/294; 427/440; 252/79.1

(57) ABSTRACT

A wood treating formulation is provided wherein the formulation is a mixture of a first solution containing styrene and a second solution containing furfuryl alcohol. A process for producing a wood treating formulation wherein the formulation is prepared by combining a first solution containing styrene and a second solution containing furfuryl alcohol is also provided.

Wood can be improved in properties like hardness, stiffness, strength, dimensional stability and resistance to deterioration by impregnating it with a polymerizable fluid and then causing the fluid to solidify within the wood structure. The resulting material is sometimes called a “wood polymer composite” or “WPC”.

There are two main types of polymers used to make WPC. One type is usually polymerized by a chain reaction initiated by free radicals developed from a carbon to carbon double bond (the vinyl group). These free radicals can be developed using chemical initiators. Typically, monomers containing vinyl groups that are used to make WPC do not interact strongly with nor enter wood cell walls. They remain in cell cavities, and the polymer formed during the free radical process also remains there. Sometimes these types of WPC are called “cell lumen WPC” for that reason. Wood cell walls remain unchanged in cell lumen WPC. Mechanical properties improvements are caused by the reinforcement from polymer in the cell cavities. The polymer in the cell cavities also greatly reduces moisture movement in the material, improving dimensional stability. Biodeterioration resistance is improved because insects and marine borers cannot chew the material very well and fungi have difficulty invading it. WO 01/53050 describes formulations and processes for making cell wall WPC from styrenic-type monomers.

The second main type of polymer used to make WPC is polymerized by a step reaction often initiated by acidic conditions. Some of the monomers used interact strongly with the wood cell wall. The furfuryl alcohol WPC described in WO 02/30638 has this mechanism. The monomer swells and enters cell walls. After polymerization the polymer remains in the cell wall, changing the basic nature of the woody substance. The impregnated woody cell walls have a different chemical composition from wood. Thus they are not recognized by many wood-deteriorating organisms and are immune to them. The new cell wall containing polymer swells very little in water, giving exceptional dimensional stability.

Thus there are two main types of WPC produced using two main types of polymer. These two main types of polymers are produced by entirely different reaction mechanisms and using very different initiators. The reaction mechanisms of their monomers are so different that the idea of mixing these monomers in a single formulation and then producing a polymer with the mixture would not be expected to someone skilled in the art.

However, there are situations where cell lumen WPC or cell wall WPC alone does not give required properties. A combination of filled cell cavities and modified cell walls would be better. A material combining wood, cell lumen and cell wall polymers. would be superior to either type for extreme service conditions. It is with this in mind that we decided to attempt combining these two very different types of polymers to make a “combination” WPC.

We mixed initiated styrene with initiated furfuryl alcohol and polymerized the mixture using heat. To our surprise, a solid polymer was formed. Furthermore, wood impregnated with the mixture swelled, indicating that the furfuryl alcohol part of the mixture entered the cell walls. When heated, a WPC having good mechanical properties and a permanently swelled state was formed. We found that a requirement for good polymerization was higher amounts of free radical initiator in the styrene than needed in WO 01/53050 and slightly higher amounts of acidic initiator was needed in the furfuryl alcohol than in WO 02/30638.

The mixtures used were the following:

TABLE 1
Combination monomer formulation.

| Chemical | | Function |
|---|---|---|
| Styrene | | Main |
| | | monomer |
| | % based on styrene | |
| 2,2′-Azobis(2- | 0.3 | Lower temperature styrene |
| methylbutane- | | initiator |
| nitrile) | | |
| 1,1′- | 0.4 | Higher temperature styrene |
| azobis(cyanocyclo | | initiator |
| hexane- | | |
| carbonitrile) | | |
| Tertiary butyl- | 0.5 | Highest temperature styrene |
| perbenzoate | | initiator |
| Divinyl benzene | 3.5 | Crosslinker for styrene |
| Mineral oil or wax | 0 to 30 | Optional extender |
| Furfuryl alcohol | 10 to 30 | Co-monomer |
| | % based on furfuryl | |
| | alcohol | |
| Maleic anhydride | 5 to 10 | Initiator for furfuryl alcohol |

The procedure required for successful mixing of this formulation is to first prepare two solutions at room temperature. One solution is prepared by dissolving initiators and crosslinker in styrene. This results in a clear-coloured solution. The second solution is prepared by dissolving solid maleic anhydride initiator in furfuryl alcohol. This results in a greenish solution. Then the solutions of styrene and its additives and furfury alcohol containing its additive are combined. This results in a light green solution which is the final treating mixture. The method of mixing is reflected in the way the formulation is given in Table 1, with styrene additive concentrations based on styrene and the furfuryl alcohol initiator concentration based on furfuryl alcohol. However, the 10% to 30% furfuryl alcohol added to styrene (based on the styrene) already contains maleic anhydride.

Mixing styrene and furfuryl alcohol and then adding all the initiators and crosslinker resulted in a yellow solution that began precipitating solids in a few hours. It proved useless for treating wood.

A vacuum-pressure process identical to that used in WO 01/53050 and WO 02/30638 is used to impregnate the formulation into wood. Curing is accomplished using heat in an identical schedule as that used in WO 01/53050.

The wood treating solution is impregnated by immersing wood in the formulation and applying a vacuum and pressure cycle to, force the formulation into the wood. Polymerization (curing) of the treating formulation impregnated in the wood is carried out by heating. The polymerization is carried out by heating the impregnated wood sufficiently for it to reach 80 C in the center. Finishing the polymerization for products where odour must be kept to a minimum is carried out by heating the impregnated wood sufficiently for it to reach 120 C in the center for at least one hour.

The amber or brownish coloured polymer formed from these mixtures had hardness similar to styrene polymer without furfuryl alcohol. Grinding the mixed polymer and leaching it with solvents for furfiryl alcohol caused no dissolution. These tests showed that polymerization occurred in both the styrene and furfuryl alcohol monomers.

We found that useful, polymerizable mixtures could be made in the range of 10% to 30% furfuryl alcohol in styrene. The amount of maleic anhydride initiator needed for the furfuryl alcohol was in the range of 5% to 10% based on furfuryl alcohol. For higher amounts of furfuryl alcohol in styrene, higher amounts of maleic anhydride were needed in the mixture.

We then used mixtures with 15% and 30% furfuryl alcohol in styrene to impregnate pine and beech wood to form a WPC. Controls with no furfuryl alcohol in the mix were used for comparison. Wood swelling behaviour was observed during treatment and after curing. The results are shown in Table 2.

The results in Table 2 show that the styrenic monomer containing furfuryl alcohol impregnate wood well. The results show that there is swelling of the wood cell walls when furfaryl alcohol is included in the mix, and that the swelling takes some hours to reach maximum. Typically, there is residual swelling after cure. Swelling is greater in the hardwoods tested (beech and birch) than in the pine. Since there is more cell wall material per unit volume of wood, it is reasonable that the hardwoods had higher residual swelling than pine. The initial and residual swelling shows that the furfuryl alcohol in the mixture enters cell walls and remains there after the curing reaction.

TABLE 2
Permanent swell and shrink of wood by furfuryl alcohol solution in styrene, before, during and after cure.

| | | | | | Pre-cure | | | | | | | |
|---|---|---|---|---|---|---|---|---|---|---|---|---|
| | | | | | diffusion period | | | | Cured | | | |
| | | | | | 1 h after | | | | 10 h @ | | | |
| | | UT-oven dry | | | impreg. | | 3 h | 16 h | 100 C. | | Poly | |
| % Fur | | Wt | Width | Growthring | Wt | Wdth | Wdth | Wdth | Wt | Wdth | Load | Postcure +swell or |
| furyl alcohol | Species | (g) | (mm) | algnmt (width) | (g) | (mm) | (mm) | (mm) | (g) | (mm) | (%) | −shrink (%) |
| 1.15 | pine | 17.16 | 29.00 | T | 47.09 | 29.06 | 29.09 | 29.07 | 44.30 | 28.70 | 158 | −1.03 |
| | beech | 74.86 | 23.88 | T/R | 114.32 | 23.86 | 23.93 | 24.04 | 112.42 | 24.50 | 50 | +2.60 |
| | birch | 20.70 | 19.20 | T | 38.44 | 19.28 | 19.28 | 19.42 | 36.82 | 19.54 | 78 | +1.77 |
| 2.15 | pine | 17.92 | 29.82 | T | 49.08 | 29.81 | 29.84 | 29.82 | 45.80 | 28.94 | 156 | −2.95 |
| | beech | 74.73 | 23.87 | T/R | 114.33 | 23.91 | 23.93 | 24.02 | 112.17 | 24.30 | 50 | +1.80 |
| | birch | 21.33 | 19.36 | T | 39.18 | 19.38 | 19.43 | 19.53 | 37.05 | 19.71 | 74 | +1.81 |
| 3.30 | pine | 17.70 | 28.97 | T | 48.76 | 29.00 | 29.05 | 29.10 | 44.29 | 30.00 | 150 | +3.56 |
| | beech | 74.23 | 23.75 | T/R | 115.72 | 23.79 | 23.85 | 24.07 | 111.01 | 25.20 | 50 | +6.11 |
| | birch | 20.53 | 19.32 | T | 38.84 | 19.40 | 19.51 | 19.80 | 35.97 | 20.45 | 75 | +5.85 |
| 4.30 | pine | 17.47 | 29.14 | T | 48.78 | 29.15 | 29.10 | 29.17 | 41.06 | 30.00 | 135 | +2.95 |
| | beech | 73.37 | 23.75 | T/R | 115.02 | 23.73 | 23.77 | 24.00 | 110.50 | 25.06 | 51 | +5.52 |
| | birch | 20.87 | 19.36 | T | 39.41 | 19.36 | 19.40 | 19.68 | 37.18 | 19.98 | 78 | +3.20 |

| | | | | | | | | | | | |
|---|---|---|---|---|---|---|---|---|---|---|---|
| 5.0 | pine | 17.30 | 29.31 | T | 47.65 | 29.28 | no change | 45.56 | 28.51 | 163 | −2.73 |
| | beech | 74.91 | 23.84 | T/R | 113.84 | 23.84 | | 112.32 | 23.71 | 50 | −0.55 |
| | birch | 21.14 | 19.20 | T | 38.12 | 19.19 | | 37.44 | 18.80 | 77 | −2.08 |
| 6.0 | pine | 16.91 | 29.11 | T | 44.72 | 29.05 | no change | 37.96 | 28.52 | 124 | −2.03 |
| | beech | 75.48 | 23.74 | T/R | 114.24 | 23.73 | | 111.74 | 23.45 | 48 | −1.22 |
| | birch | 20.93 | 19.30 | T | 38.79 | 19.27 | | 37.24 | 18.63 | 78 | −3.47 |

Notes:
Formulations 1 to 4 contain furfuryl alcohol with 7% maleic anhydride initiator (based on the furfuryl alcohol), formulations 5 and 6 are controls containing no furfuryl alcohol, formulations 1, 3 and 5 contain mineral oil in the formulation and the others do not. All contain styrene, divinyl benzene and the 3 initiators listed in Table 1.

Swelling during treatment is caused by liquid furfuryl alcohol penetrating wood cell walls. Residual swelling after cure means that some furfuryl alcohol remains in the cell walls. But its state is unknown. To be a useful treatment for wood, the furfuryl alcohol must cure (polymerize) in the cell walls so it cannot be leached out by water. Soaking in water and observing swelling and leaching behaviour was done next. Results are in Table 3.

TABLE 3
Water leaching and swelling of combination treatments.

| | | | | | Losses from combined wood | | | | |
|---|---|---|---|---|---|---|---|---|---|
| | | | | | and polymer (WPC) | | | | |
| | | | PL | | | | | | Loss |
| | | | (see | | Wt. | | | Loss | 7. Boil |
| | | % | note | | 4. Re- | Wt. Loss | Loss | 6. Dry | only |
| | | furfuryl | 8) | 3. ASE | dried | 5. Boil + dry | Boil + dry | only | (Leached) |
| Species | Board | alcohol | (%) | (%) | (g) | (g) | (%) | (%) | (%) |
| Beech | a | 10 | 64.4 | 29.9 | 4.636 | 0.178 | 3.7 | 0.9 | 2.8 |
| | | 15 | 72.7 | 33.2 | 4.084 | 0.228 | 5.3 | 2.1 | 3.2 |
| | | 20 | 68.2 | 35.5 | 4.011 | 0.17 | 4.1 | 0.6 | 3.5 |
| | | 25 | 70.0 | 37.1 | 4.082 | 0.252 | 5.8 | 1.9 | 4.0 |
| | | Untreated | | 0.0 | 2.714 | 0.051 | 1.8 | 0.0 | 1.8 |
| Beech | b | 10 | 63.1 | 26.1 | 4.354 | 0.121 | 2.7 | 0.3 | 2.4 |
| | | 15 | 64.6 | 31.7 | 4.256 | 0.18 | 4.1 | 0.6 | 3.4 |
| | | 20 | 65.1 | 35.8 | 3.414 | 0.169 | 4.7 | 0.6 | 4.1 |
| | | 25 | 63.5 | 37.1 | 4.147 | 0.26 | 5.9 | 1.7 | 4.2 |
| | | Untreated | | 0.0 | 3.201 | 0.063 | 1.9 | 0.0 | 1.9 |
| Pine | a | 10 | 119.4 | 55.2 | 3.262 | 0.265 | 7.5 | 5.5 | 2.0 |
| | | 15 | 115.2 | 55.0 | 1.927 | 0.237 | 11.0 | 7.5 | 3.5 |
| | | 20 | 111.5 | 55.3 | 3.031 | 0.317 | 9.5 | 7.2 | 2.2 |
| | | 25 | 115.1 | 44.6 | 3.134 | 0.482 | 13.3 | 10.2 | 3.2 |
| | | Untreated | | 0.0 | 1.636 | 0.049 | 2.9 | 0.0 | 2.9 |
| Pine | b | 10 | 101.2 | 35.0 | 2.02 | 0.139 | 6.4 | 3.0 | 3.5 |
| | | 15 | 100.7 | 33.8 | 2.171 | 0.207 | 8.7 | 6.3 | 2.4 |
| | | 20 | 106.4 | 43.7 | 2.159 | 0.16 | 6.9 | 3.8 | 3.1 |
| | | 25 | 110.9 | 40.9 | 1.894 | 0.157 | 7.7 | 4.4 | 3.2 |
| | | Untreated | | 0.0 | 1.277 | 0.034 | 2.6 | 0.0 | 2.6 |

Notes:
1. Cured for 3.5 h of 100 C. steam, followed by 18 h of 120 C. hot air.
2. Water-saturated using 20 minutes of full vacuum, followed by 2 h of 7 bar presure
3. Anti Swell Efficiency, ASE = 100 × (Sc − St)/Sc where Sc = swell of untreated control, St = swell of treated material
4. Specimens boiled for 4 hours after water saturation swell measurements and then re-dried 14 h at 120 C.
5. Combined weight loss resulting from the 4 h of vigorous water boiling followed by 14 h hot air oven drying at 120 C.
6. Weight losses (%) from hot air oven drying only, determined on parallel-tested, matched-slice control specimens.
7. Weight loss from the 4 h water boil (corrected for subsequent oven drying losses).
8. Polymer Loading (%) (cured as in 1. above) based on untreated ovendry weight.
9. An estimate because of the unknown interaction of wood extractives and monomer mix (and additives) in the polymerization reaction make it difficult to isolate a true polymer leach value, especially evident in the low (or negative) values of polymer leach in the pine.

The results shown in Table 3 show that weight losses from water-leached WPC formed from the combination of styrene and furfuryl alcohol polymers are much less than the original amount of furfuryl alcohol in the mix. This confirms that the furfuryl alcohol is mostly polymerized. When soaked and boiled in water and then redried, the material retained an antiswell efficiency. This showed that the furfuryl alcohol polymerized in the wood cell walls. It was insoluble in water and kept the cell walls permanently partially swollen.

The above has shown how the furfuryl alcohol in the mix behaves in wood. The evidence that the styene polymerized was lack of odour and physical and mechanical properties increase. Since the styrene polymer was the major part of the mixture, it contributed most to the high polymer loading, in Table 3. Had the styrene evaporated from the mixture in the wood, polymer loadings would have been in the range of the furfuryl alcohol concentration in the mix (5% to 30%) rather than those observed (64% to 120%). There was little styrene odour from the treated samples, indicating good polymerization. Hardness is a good mechanical property indicator of polymerization. Hardnesses of WPC made with the mixture are given in Table 4.

TABLE 4
Brinell hardness of wood treated with
polystyrene-poly furfuryl alcohol mixture.

| | | Ball indent diameter | | | | | | |
|---|---|---|---|---|---|---|---|---|
| | | on newly cut, | | | | | | |
| | % furfuryl | radial surfaces | | | | | | |
| Species | alcohol | D1 | d2 | d3 | D4 | D5 | Davg | BHN |
| Beech | 10 | 3.8 | 3.6 | 3.6 | 3.5 | 3.5 | 3.6 | 7.7 |
| | 0 | 6.8 | 6.8 | 6.9 | 6.8 | 6.7 | 6.8 | 2.0 |
| | (control) | | | | | | | |
| Pine | 10 | 4.7 | 4.2 | 4.2 | 4.5 | 4.4 | 4.4 | 5.1 |
| | 0 | 6.8 | 6.2 | 6.5 | 6.7 | 6.9 | 6.6 | 2.1 |
| | (control) | | | | | | | |

Notes:
ball diameter = 11.1 mm
load = 0.7878 kN

The hardness results in Table 4 show that woods treated with a styrene-furfuryl alcohol mixture are considerably harder than untreated wood. This shows that polymerization occurred and the polymer reinforced the wood.

The ranges of these results are summarized in Table 5.

TABLE 5
Summarized leach loss and ASE from Tables 2 and 3.

| | Percent | Percent water | | | | |
|---|---|---|---|---|---|---|
| | furfuryl | boil leach loss | | Percent ASE | | Brinell |
| Species | alcohol | range | median | range | median | Hardness |
| Beech | 10 | 2.4-2.8 | 2.6 | 26-30 | 28 | 7.7 |
| | 15 | 3.2-3.4 | 3.3 | 32-33 | 32 | |
| | 20 | 3.5-4.1 | 3.8 | 35-36 | 35 | |
| | 25 | 4.0-4.2 | 4.1 | 37 | 37 | |
| | Untreated | 1.8-1.9 | 1.8 | 0 | | 2.0 |
| | control | | | | | |
| Pine | 10 | 2.0-3.5 | 2.8 | 35-55 | 45 | 5.1 |
| | 15 | 2.4-3.5 | 3.0 | 34-55 | 45 | |
| | 20 | 2.2-3.1 | 2.7 | 44-55 | 50 | |
| | 25 | 3.2 | 3.2 | 41-45 | 43 | |
| | Untreated | 2.9-2.6 | 2.8 | 0 | | 2.1 |
| | control | | | | | |

Table 5 allows the following conclusions to be made. Catalyzed furfuryl alcohol in catalyzed styrene. enters wood cell walls and cures there, causing a permanent change in the wood cell wall. The styrene polymer fills the cell cavities with polymer, reinforcing the wood. Therefore there is a true combination of cell lumens filled with polystyrene and cell walls containing poly furfuryl alcohol.

Wood treated with styrene alone has its wood substance (the cellulose, lignin and hemicelluloses) of the cell wall unchanged. That leaves the treated wood susceptible to moisture and biodeterioation effects, although at much slower rate than untreated wood. The implications of using the styrene-furfaryl alcohol combination described above, with the cell wall modified, are that the WPC will be less susceptible to moisture and biodeterioration than wood treated with styrene alone but will have the superior mechanical properties of WPC made with cell lumens filled by polystyrene. The resistance to moisture and biodeterioration of the WPC are expected to be similar to that described in WO 02/060660 which has the same concentrations of furfuryl alcohol polymer in the cell walls, but without the polystyrene present. Therefore an improved wood polymer composite is formed by the combination of styrene and furfuryl alcohol.

1. A wood treating formulation, characterized in that the formulation is a mixture of a first solution containing styrene and a second solution containing furfuryl alcohol.

2. The wood treating formulation of claim 1, characterized in that the first solution further consists of initiators and a crosslinker, and the second solution further consists of an initiator.

3. The wood treating formulation of claim 2, characterized in that the initiators of the first solution are a combination of 2,2′-azobis(2-methylbutane-nitrile), 1,1′-azobis(cyclohexane-carbonitrile) and tertiary butyl perbenzoate.

4. The wood treating formulation of claim 2, characterized in that the crosslinker of the first solution is divinyl benzene.

5. The wood treating formulation of claim 2, characterized in that a mineral oil or wax optionally is present in the first solution as an extender.

6. The wood treating formulation of claim 2, characterized in that the initiator of the second solution is maleic anhydride.

7. The wood treating formulation of claim 3, characterized in that about 0,3% of 2,2′-azobis(2-methylbutane-nitrile) based on styrene is present in the first solution.

8. The wood treating formulation of claim 3, characterized in that about 0,4% of 1,1′-azobis(cyclohexane-carbonitrile) based on styrene is present in the first solution.

9. The wood treating formulation of claim 3, characterized in that about 0,5% of tertiary butyl perbenzoate based on styrene is present in the first solution.

10. The wood treating formulation of claim 4, characterized in that about 3,5% of divinyl benzene based on styrene is present in the first solution.

11. The wood treating formulation of claim 5, characterized in that 0 to 30% of mineral oil or wax based on styrene is present in the first solution.

12. The wood treating formulation of claim 1, characterized in that 10 to 30% of furfuryl alcohol, which is based on the styrene of the first solution, is present in the second solution.

13. The wood treating formulation of claim 6, characterized in that 5 to 10% of maleic anhydride based on furfuryl alcohol is present in the second solution.

14. A process for producing a wood treating formulation, characterized in that the formulation. is prepared by combining a first solution containing styrene and a second solution containing furfuryl alcohol.

15. The process of claim 14, characterized in that the first solution is prepared by dissolving initiators and a crosslinker in the styrene, and the second solution is prepared by dissolving an initiator in the furfuryl alcohol.

16. The process of claim 15, characterized in that the initiators of the first solution are selected from a combination of 2,2′-azobis(2-methylbutane-nitrile), 1,1′-azobis(cyclohexane-carbonitrile) and tertiary butyl perbenzoate.

17. The process of claim 15, characterized in that the crosslinker of the first solution is divinyl benzene.

18. The process of claim 15, characterized in that a mineral oil or wax optionally is present in the first solution as an extender.

19. The process of claim 15, characterized in that the initiator of the second solution is maleic anhydride.

20. The process of claim 16, characterized in that about 0,3% of 2,2′-azobis(2-methylbutane-nitrile) based on styrene is present in the first solution.

21. The process of claim 16, characterized in that about 0,4% of 1,1′-azobis-(cyanocyclohexane-carbonitrile) based on styrene is present in the first solution.

22. The process of claim 16, characterized in that about 0,5% of tertiary butyl perbenzoate based on styrene is present in the first solution.

23. The process of claim 17, characterized in that about 3,5% of divinyl benzene based on styrene is present in the first solution.

24. The process of claim 18, characterized in that 0 to 30% of mineral oil or wax based on styrene is present in the first solution.

25. The process of claim 14, characterized in that 10 to 30% of furfuryl alcohol, which is based on the styrene of the first solution, is present in the second solution.

26. The process of claim 19, characterized in that 5 to 10% of maleic anhydride based on furfuryl alcohol is present in the second solution.

27. The process of claim 14, characterized in that the wood treating solution is impregnated by immersing wood in the formulation and applying a vacuum and pressure cycle to force the formulation into the wood.

28. The process of claim 14, characterized in that curing of the treating formulation impregnated in the wood is carried out by heating.

29. The process of claim 28, characterized in that polymerization is carried out by heating the impregnated wood sufficiently for it to reach 80 C in the center.

30. The process of claim 28, characterized in that finishing polymerization for products where odour must be kept to a minimum is carried out by heating the impregnated wood sufficiently for it to reach 120 C in the center for at least one hour.
